(19) United States
(12) Patent Application Publication
(10) Pub. No.: US 2026/0095002 A1
(43) Pub. Date: Apr. 2, 2026

(54) ELECTRICAL CONNECTOR HAVING TERMINALS INCORPORATING PASSIVE ELECTRONIC COMPONENTS

(71) Applicant: TE Connectivity Solutions GmbH, Schaffhausen (CH)

(72) Inventor: Christopher Ryan Raybold, Middletown, PA (US)

(21) Appl. No.: 18/898,759

(22) Filed: Sep. 27, 2024

(51) Int. Cl. H01R 13/696; H01R 12/77; H01R 13/187; H01R 13/447; H01R 13/64

(52) U.S. Cl. CPC H01R 13/696; H01R 12/778; H01R 13/187; H01R 13/447; H01R 13/64

(57) ABSTRACT

An electrical connector assembly includes a flat flexible cable (FFC) having a substrate holding conductors. The conductors have ends at an end of the FFC. The electrical connector assembly includes an electrical connector terminated to the end of the FFC. The electrical connector includes a housing holding terminals. The terminals are terminated to ends of the corresponding conductors. At least one of the terminals includes a passive electronic component in-line with the terminal.

### BACKGROUND OF THE INVENTION

The subject matter herein relates generally to electrical connectors.

Electrical connectors are used in various systems and applications to electrically connect components or devices. The electrical connector includes a housing holding contacts or terminals. The terminals are electrically connected to a circuit board or cable assembly. In some applications it may be desirable to control the transmission lines, such as to provide active or passive functions to the transmission lines. For example, passive electrical components may be added to the system to process or control the transmission lines. For example, the terminals may be electrically connected to a circuit board, and passive electrical components are mounted to the circuit board to control the transmissions. However, providing the circuit board and the passive electrical components on the circuit board add cost to the overall system. Additionally, the use of the circuit board increases the overall size of the electrical connector. Some systems do not include a circuit board and thus are unable to incorporate passive electronic components into the connector in this manner.

A need remains for an electrical connector having terminals incorporating passive electronic components.

### BRIEF DESCRIPTION OF THE INVENTION

In one embodiment, an electrical connector assembly is provided and includes a cable assembly having conductors. The conductors have ends at an end of the cable assembly. The electrical connector assembly includes an electrical connector terminated to the end of the cable assembly. The electrical connector includes a housing holding terminals. The housing extends between a mating end and a cable end. The cable assembly extends from the cable end. The housing includes walls forming terminal channels that receive the corresponding terminals. Each terminal includes a mating end and a terminating end opposite the mating end. The terminating end configured to be terminated to the corresponding conductor of the cable assembly. The terminal includes a main body between the mating end and the terminating end. The main body includes a first pad, a second pad, and a sacrificial section between the first pad and the second pad. The sacrificial section configured to be removed to separate the first and second pads. The terminal is configured to receive a passive electronic component.

In another embodiment, an electrical connector assembly is provided and includes a flat flexible cable (FFC) having a substrate holding conductors. The conductors have ends at an end of the FFC. The electrical connector assembly includes an electrical connector terminated to the end of the FFC. The electrical connector includes a housing holding terminals. The terminals are terminated to ends of the corresponding conductors. At least one of the terminals includes a passive electronic component in-line with the terminal.

In a further embodiment, a terminal for an electrical connector is provided. The terminal includes a mating end configured to be mated to a mating contact of a mating electrical connector. The terminal includes a terminating end opposite the mating end configured to be terminated to a conductor of a cable assembly. The terminal includes a main body between the mating end and the terminating end. The main body includes a first pad, a second pad, and a sacrificial section between the first pad and the second pad. The sacrificial section configured to be removed to separate the first and second pads. The terminal includes a passive electronic component coupled to the main body in-line between the mating end and the terminating end. The passive electronic component electrically connects the first pad and the second pad after the sacrificial section is removed.

### BRIEF DESCRIPTION OF THE DRAWINGS

FIG. 1 illustrates an electrical connector assembly in accordance with an exemplary embodiment.

FIG. 2 is a cross-sectional view of the electrical connector assembly in accordance with an exemplary embodiment.

FIG. 3 is a perspective view of one of the terminals in accordance with an exemplary embodiment.

FIG. 4 is a top view of a portion of the electrical connector in accordance with an exemplary embodiment showing a plurality of the terminals loaded into the terminal channels of the housing.

FIG. 5 is an enlarged top view of a portion of the electrical connector in accordance with an exemplary embodiment showing one of the terminals loaded into the corresponding terminal channel of the housing.

FIG. 6 is a cross-sectional view of a portion of the electrical connector in accordance with an exemplary embodiment showing one of the terminals in the housing without a passive electronic component.

FIG. 7 is a cross-sectional view of a portion of the electrical connector in accordance with an exemplary embodiment showing one of the terminals in the housing with the passive electronic component coupled thereto.

FIG. 8 is a top view of a portion of the electrical connector in accordance with an exemplary embodiment showing a plurality of the passive electronic component connected in-line with the corresponding terminals.

### DETAILED DESCRIPTION OF THE INVENTION

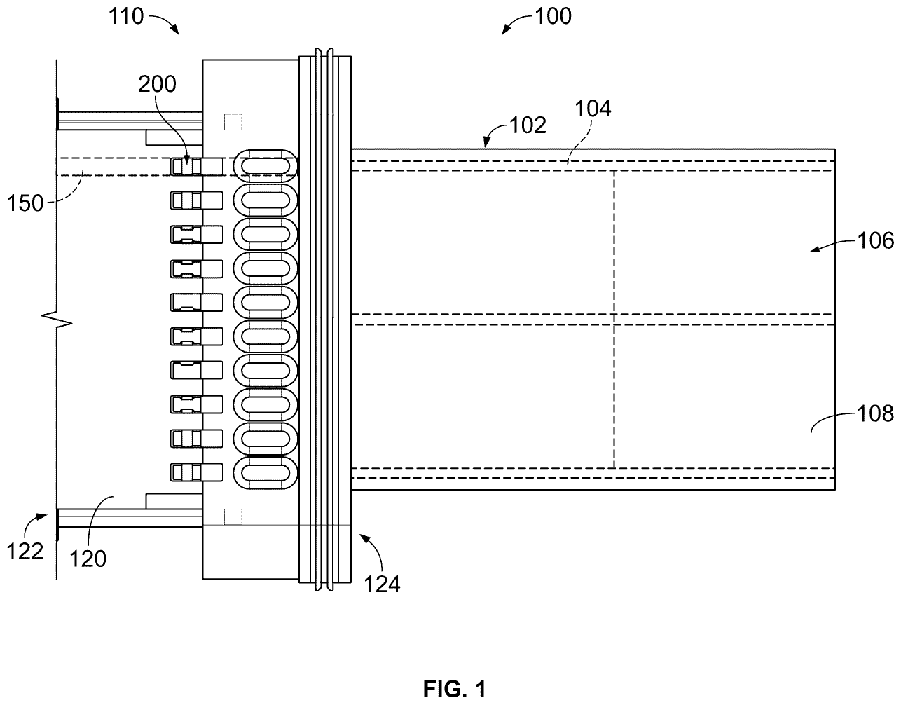

FIG. 1 illustrates an electrical connector assembly 100 in accordance with an exemplary embodiment. The electrical connector assembly 100 includes an electrical connector 110 terminated to an end of a cable assembly 102. The electrical connector 110 is configured to be mated with a mating electrical connector (not shown) in an exemplary embodiment, the electrical connector 110 incorporates one or more passive electronic components 200 along the transmission lines to provide the passive electronic components 200 between the cable assembly 102 in the mating electrical connector.

The electrical connector assembly 100 may be used in various types of electrical systems. For example, the electrical connector assembly 100 may be used in a power system, such as a battery system of a vehicle, such as a battery pack to connect battery cells together or to another component of the battery system. The electrical connector assembly 100 may be used in a communication system, such as a network device, a server, a computer, or other type of data communication system.

The cable assembly 102 includes a plurality of conductors 104 electrically coupled to the electrical connector 110. In an exemplary embodiment, the cable assembly 102 includes a flat flexible cable 106 (FFC 106) having a substrate 108 holding the conductors 104. However, the cable assembly 102 is not limited to FFC. Rather, the cable assembly 102 may include individual cables or wires, such as single ended wires, coaxial cables, twin-axial cables, ribbon cables, and the like. The cable assembly 102 may include a flexible printed circuit in other various embodiments.

The electrical connector 110 is terminated to the end of the cable assembly and electrically connected to the conductors 104 of the cable assembly 102. The electrical connector 110 includes a housing 120 holding a plurality of terminals 150. The terminals 150 are configured to be electrically connected to the corresponding conductors 104 of the cable assembly 102. The terminals 150 may be power terminals, signal terminals, ground terminals, or other types of terminals. In an exemplary embodiment, one or more of the terminals 150 incorporate the passive electronic components 200. For example, the passive electronic components 200 are electrically connected in-line with the terminal 150. The passive electronic components 200 may include protection devices, such as fuses, resistors or other passive protection devices. The passive electronic components 200 may include electronic devices that perform passive operations like consuming, storing, or releasing electric power. For example, the passive electronic components 200 may include capacitors, resistors, inductors, and the like. The passive electronic components 200 may store energy in an electric or magnetic field, absorb energy, dissipate energy, control complex circuits or signals, produce a phase shift to the signal, provide some form of feedback, or perform other passive functions.

The housing 120 extends between a mating end 122 and a cable end 124. In the illustrated embodiment, the cable end 124 is opposite the mating end 122. For example, the mating end 122 is located at a front of the housing 120 and the cable end 124 is located at a rear of the housing 120. Other orientations are possible in alternative embodiments. For example, the housing 120 may be a right-angle housing having the cable end 124 perpendicular to the mating end 122. In an exemplary embodiment, the end of the cable assembly 102 extends into the housing 120 to electrically connect to the terminals 150. The housing 120 may have any desired shape, such as rectangular, oval, or other shape. In various embodiments, the mating end 122 may define a plug end of the electrical connector 110 configured to be plugged into a receptacle of the mating electrical connector. Alternatively, the mating end 122 may define a receptacle of the electrical connector 110 configured to receive a plug end of the mating electrical connector.

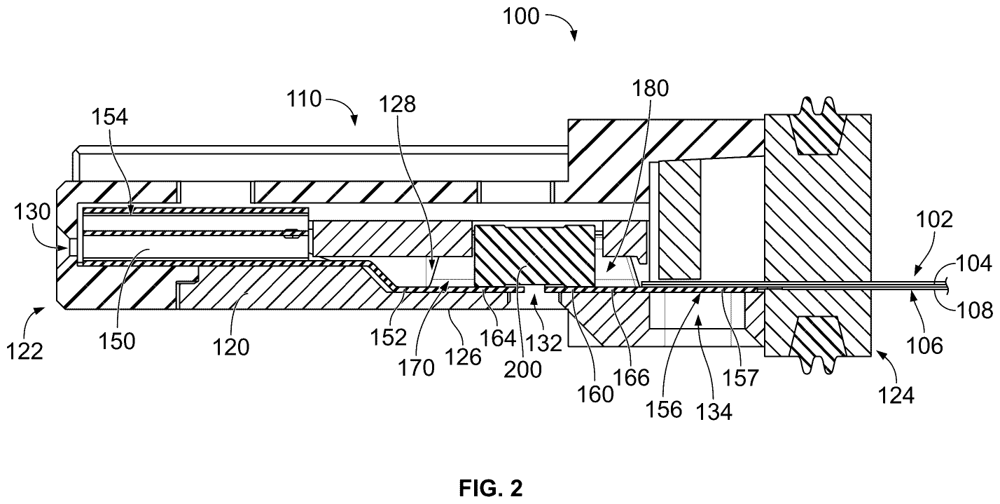

FIG. 2 is a cross-sectional view of the electrical connector assembly 100 in accordance with an exemplary embodiment. FIG. 2 shows the terminals 150 received in the housing 120 and the conductor 104 of the cable assembly 102 terminated to the end of the terminals 150. FIG. 2 also shows the passive electronic component 200 electrically connected in-line with the terminal 150.

The housing 120 includes walls 126 forming terminal channels 128 that receive the terminals 150. For example, the walls 126 may include upper walls, lower walls, side walls, front walls, rear walls, and the like surrounding and defining the terminal channels 128. The housing 120 is manufactured from a dielectric material, such as a plastic material, to provide electrical isolation between the terminals 150. The housing 120 may be manufactured from a molding process, such as an injection molding process. In various embodiments, the housing 120 is a multipiece housing having separate and discrete molded housing portions that are coupled together to form the housing 120. In alternative embodiments, the housing 120 may be a single piece housing manufactured from a single molding process.

In an exemplary embodiment, the housing 120 includes openings 130 that provide access to the terminals 150. For example, the housing 120 may be open at the front to allow mating of the terminals 150 to the mating terminals of the mating electrical connector. The housing 120 may be open at the rear to allow the cable assembly 102 to enter the housing 120.

In an exemplary embodiment, the openings 130 include terminal access openings 132 that allow access to the terminals 150 for preparation of the terminals 150 for connection of the passive electronic components 200 to the terminals 150. For example, the terminal access openings 132 allow access to the terminals 150 for removal of portions of the terminals 150 to create discontinuities along the terminals 150 for connection of the passive electronic components 200 at the discontinuities.

In the illustrated embodiment, the access opening 132 is located at the bottom of the housing 120. Other locations are possible in alternative embodiments. In an exemplary embodiment, the openings 130 include cable access openings 134 that allows access to the interfaces between the ends of the terminals 150 and the ends of the conductors 104 of the cable assembly 102 for termination of the terminals 150 to the conductors 104. For example, the terminals 150 may be welded or soldered to the conductors 104 through the cable access openings 134.

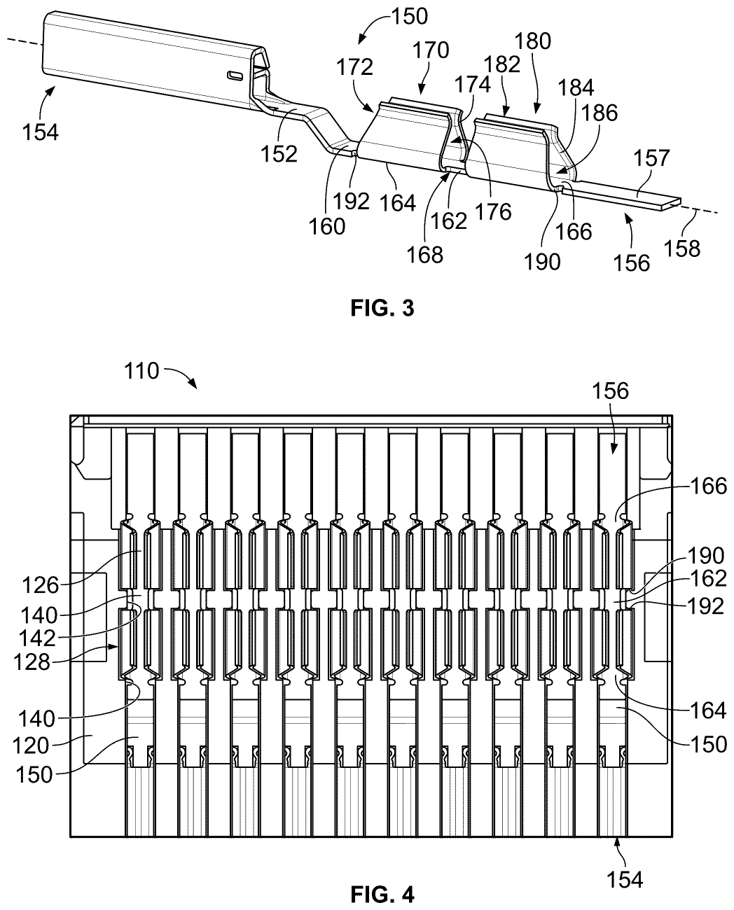

With additional reference to FIG. 3, which is a perspective view of one of the terminals 150 in accordance with an exemplary embodiment, the terminal 150 includes a metal body 152 extending between a mating end 154 and a terminating end 156. The terminals 150 includes a main body 160 between the mating end 154 and the terminating end 156. The terminal 150 generally extends along a longitudinal terminal axis 158. For example, the mating end 154, the terminating end 156, and the main body 160 may extend generally parallel to each other. However, in alternative embodiments, the terminating end 156 may extend at an angle relative to the mating end 154, such as perpendicular to the mating end 154.

In an exemplary embodiment, the metal body 152 is a stamped and formed body configured to be stamped from a metal sheet and formed into a predetermined shape. The metal body 152 forms an integral, unitary structure with the mating end 154, the main body 160, and the terminating end 156 being integral when stamped and formed. In an exemplary embodiment, a portion of the main body 160 is configured to be removed after the terminal 150 is located in the housing 120 for connection of the passive electronic component 200 in-line with the main body 160 to connect the separated portions of the terminal 150 through the passive electronic component 200.

The mating end 154 is located at the front of the terminal 150. The mating end 154 is configured to be mated with the mating terminals of the mating electrical connector. The mating end 154 may take different forms depending on the particular application. In the illustrated embodiment, the mating end 154 includes a socket configured to receive a pin of the mating terminal. In alternative embodiments, the mating end 154 may have other forms, such as a pin, a spring beam, a blade, a tulip receptacle, or another type of mating interface.

The terminating end 156 is located at the rear of the terminal 150. The terminating end 156 is configured to be terminated to the corresponding conductor 104 of the cable assembly 102. The terminating end 156 may take different forms depending on the particular application. In the illustrated embodiment, the terminating end 156 includes a weld pad 157 configured to be welded to the conductor 104. The weld pad 157 may be planar. In alternative embodiments, the terminating end 156 may have other forms, such as a crimped barrel, and insulation displacement contact, or another type of terminating interface.

The main body 160 transitions between the mating end 154 and the terminating end 156. In an exemplary embodiment, the main body 160 includes a first pad 164 extending from the mating end 154 and a second pad 166 extending from the terminating end 156. In an exemplary embodiment, the main body 160 includes a sacrificial section 162 between the first pad 164 and the second pad 166. The sacrificial section 162 is configured to be removed during the assembly process to separate the first pad 164 from the second pad 166. The sacrificial section 162 may be an area of reduced cross-section. For example, the main body 160 may form a neck 168 between the first and second pads 164, 166 having a with that is narrower than other sections of the main body 160. The passive electronic component 200 is configured to bridge between the first pad 164 and the second pad 166 after the sacrificial section 162 is removed. In an exemplary embodiment, some of the terminals 150 within the electrical connector 110 may remain intact with the sacrificial section 162 remaining between the first and second pads 164, 166. Such terminals do not receive the passive electronic components 200. Rather, the passive electronic components 200 are utilized with the terminals 150 having the sacrificial sections 162 removed.

In an exemplary embodiment, the terminal includes a first passive component connector 170 extending from the first pad 164. The first passive component connector 170 is configured to electrically connect to the passive electronic component 200. The first passive component connector 170 includes first contact springs 172 extending from the first pad 164 for interfacing with the passive electronic component 200. In the illustrated embodiment, the first contact springs 172 extend upward from the first pad 164 and are located above the first pad 164. The first contact springs 172 include opposed first spring arms 174 on opposite sides of the first pad 164. The first spring arms 174 are deflectable relative to each other. The first spring arms 174 form a first pocket 176 configured to receive the passive electronic component 200. The first spring arms 174 may form a clamp configured to clamp against opposite sides of the passive electronic component 200 to mechanically and to electrically connect to the passive electronic component 200. The first spring arms 174 may be curved, such as being curved inward toward each other to form the first pocket 176. Optionally, the distal ends of the first spring arms 174 may be flared outward to provide a lead-in to the first pocket 176 to allow loading of the passive electronic component 200 into the first pocket 176. For example, the passive electronic component 200 may be loaded into the first pocket 176 from above through a gap or opening between the first spring arms 174. The first contact springs 172 may have other shapes in alternative embodiments. The first contact springs 172 may be located at other locations in alternative embodiments. Other types of passive component connectors may be provided to electrically connect the first pad 164 to the passive electronic component 200. For example, the passive component connector may include a weld pad or solder pad configured to be welded or soldered to an end or a lead of the passive electronic component 200.

In an exemplary embodiment, the terminal includes a second passive component connector 180 extending from the second pad 166. The second passive component connector 180 is configured to electrically connect to the passive electronic component 200. The second passive component connector 180 includes second contact springs 182 extending from the second pad 166 for interfacing with the passive electronic component 200. In the illustrated embodiment, the second contact springs 182 extend upward from the second pad 166 and are located above the second pad 166. The second contact springs 182 include opposed second spring arms 184 on opposite sides of the second pad 166. The second spring arms 184 are deflectable relative to each other. The second spring arms 184 form a second pocket 186 configured to receive the passive electronic component 200. The second spring arms 184 may form a clamp configured to clamp against opposite sides of the passive electronic component 200 to mechanically and to electrically connect to the passive electronic component 200. The second spring arms 184 may be curved, such as being curved inward toward each other to form the second pocket 186. Optionally, the distal ends of the second spring arms 184 may be flared outward to provide a lead-in to the second pocket 186 to allow loading of the passive electronic component 200 into the second pocket 186. For example, the passive electronic component 200 may be loaded into the second pocket 186 from above through a gap or opening between the second spring arms 184. The second contact springs 182 may have other shapes in alternative embodiments. The second contact springs 182 may be located at other locations in alternative embodiments. Other types of passive component connectors may be provided to electrically connect the second pad 166 to the passive electronic component 200. For example, the passive component connector may include a weld pad or solder pad configured to be welded or soldered to an end or a lead of the passive electronic component 200.

In an exemplary embodiment, the terminal 150 includes terminal locating elements 190 used for locating the terminal 150 relative to the housing 120. For example, the locating elements 190 may be provided along the main body 160. In an exemplary embodiment, the locating elements 190 include locating shoulders 192 providing surfaces for longitudinally and/or laterally positioning the terminal 150 in the terminal channel 128 of the housing 120. The locating elements 190 may include protrusions protruding outward from the main body 160 and/or pockets extending inward into the main body 160 that define the locating shoulders 192. In various embodiments, the locating shoulders 192 may be oriented generally perpendicular to the longitudinal terminal axis 158 of the terminal 150. Other orientations are possible in alternative embodiments.

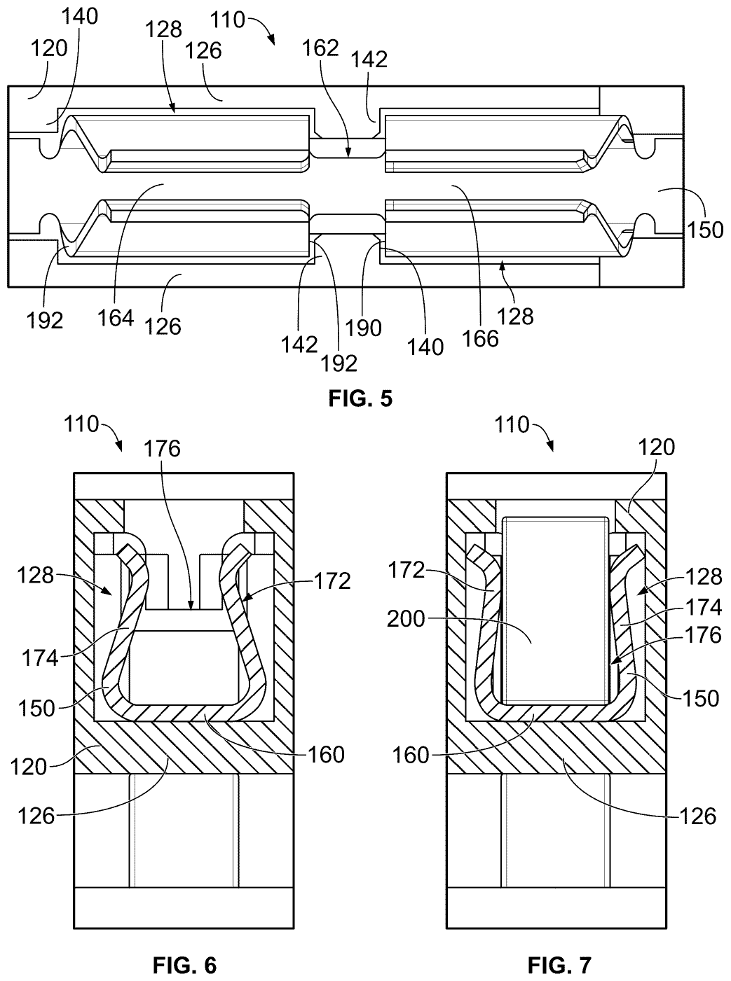

FIG. 4 is a top view of a portion of the electrical connector 110 in accordance with an exemplary embodiment showing a plurality of the terminals 150 loaded into the terminal channels 128 of the housing 120. FIG. 5 is an enlarged top view of a portion of the electrical connector 110 in accordance with an exemplary embodiment showing one of the terminals 150 loaded into the corresponding terminal channel 128 of the housing 120.

In an exemplary embodiment, the terminals 150 are arranged in a row within the corresponding terminal channels 128. The terminals 150 may be aligned with each other, such as having the mating ends 154 and the terminating ends 156 of each of the terminals 150 aligned with each other within the row. The walls 126 define the terminal channels 128 and are located between the terminals 150 to electrically isolate the terminals 150 from each other. Optionally, the terminal channels 128 may be open from above to receive the terminals 150. The terminal channels 128 may later be closed by a cover (not shown) or another portion of the housing 120 to retain the terminals 150 in the terminal channels 128.

In an exemplary embodiment, the housing 120 includes locating elements 140 used for locating the terminals 150 in the terminal channels 128. For example, the locating elements 140 may be provided along the walls 126. The locating elements 140 are configured to interface with the locating elements 190 of the terminals 150 to position the terminals 150 relative to the housing 120. In an exemplary embodiment, the locating elements 140 include locating tabs 142 providing surfaces for longitudinally and/or laterally positioning the terminals 150 in the terminal channels 128 of the housing 120. The locating shoulders 192 of the terminals 150 are configured to interface with the locating tabs 142 to axially position the terminals 150 in the terminal channels 128. Other types of locating elements may be used in alternative embodiments. In an exemplary embodiment, the locating elements 140 are configured to locate both the forward portion (for example, the first pad 164 and the mating end 154) of the terminal 150 and the rearward portion (for example, the second pad 166 and the terminating end 156) of the terminal 150. As such, when the sacrificial section 162 is removed, both the forward portion and the rearward portion are held independently in the housing 120.

FIG. 6 is a cross-sectional view of a portion of the electrical connector 110 in accordance with an exemplary embodiment showing one of the terminals 150 in the housing 120 without a passive electronic component 200. FIG. 7 is a cross-sectional view of a portion of the electrical connector 110 in accordance with an exemplary embodiment showing one of the terminals 150 in the housing 120 with the passive electronic component 200 coupled thereto.

The terminal 150 is positioned in the terminal channel 128 of the housing 120. The main body 160 rests along the bottom of the terminal channel 128 and is supported by the bottom wall 126 of the housing 120. The contact springs 172 extend upward from the main body 160. The spring arms 174 are located on opposite sides of the pocket 176. The spring arms 174 are bent inward into the pocket 176 to create a space configured to receive the passive electronic component 200. When the passive electronic component 200 is loaded into the pocket 176, the spring arms 174 are deflected outward causing the spring arms 174 to pinch inward to maintain a reliable electrical connection with the passive electronic component 200.

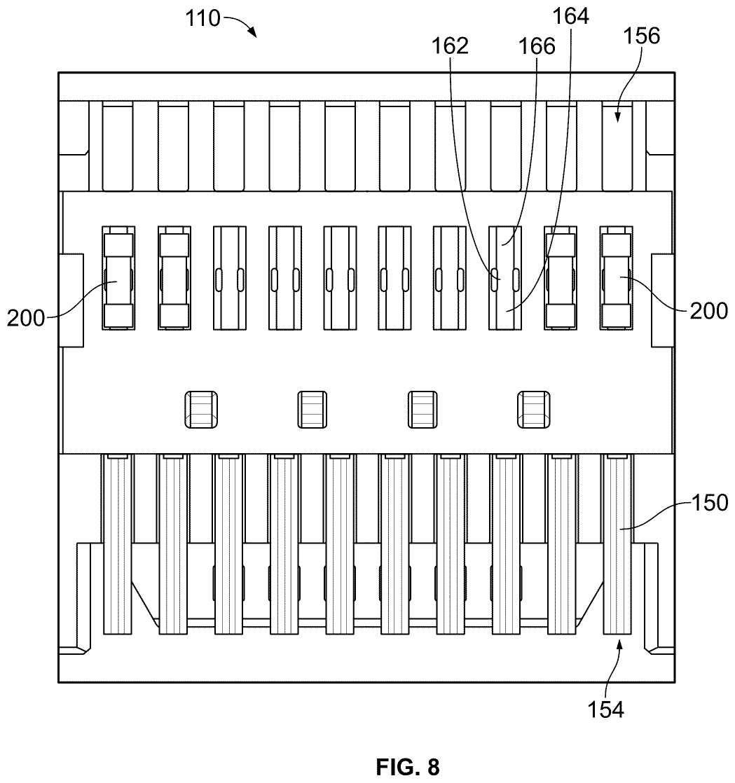

FIG. 8 is a top view of a portion of the electrical connector 110 in accordance with an exemplary embodiment showing a plurality of the passive electronic component 200 connected in-line with the corresponding terminals 150. In various embodiments, a subset of the terminals 150 receive the corresponding passive electronic components 200, while some of the terminals 150 do not receive any passive electronic components 200. Any of the terminals 150 may receive the passive electronic component 200 depending on the particular application and the transmission lines that need the passive electronic component 200. The terminals 150 that do not receive the passive electronic components 200 leave the sacrificial sections 162 intact to define the electrical path between the first pads 164 and the second pads 166. The terminals 150 that receive the passive electronic components 200 route the transmission line between the first pads 164 (and the mating ends 154) and the second pads 166 (and the terminating ends 156) through the passive electronic components 200.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

What is claimed is:

1. An electrical connector assembly comprising:
a cable assembly having conductors, the conductors having ends at an end of the cable assembly;
an electrical connector terminated to the end of the cable assembly, the electrical connector including a housing holding terminals;
the housing extending between a mating end and a cable end, the cable assembly extending from the cable end, the housing including walls forming terminal channels that receive the corresponding terminals;
each terminal including a mating end and a terminating end opposite the mating end, the terminating end configured to be terminated to the corresponding conductor of the cable assembly, the terminal including a main body between the mating end and the terminating end, the main body including a first pad, a second pad, and a sacrificial section between the first pad and the second pad, the sacrificial section configured to be removed to separate the first and second pads,
wherein the terminal is configured to receive a passive electronic component.

2. The electrical connector assembly of claim 1, wherein the first pad is electrically connected to the second pad through the passive electronic component when the sacrificial section is removed.

3. The electrical connector assembly of claim 1, wherein the cable assembly includes a flat flexible cable having a substrate holding the conductors.

4. The electrical connector assembly of claim 1, wherein the housing includes access openings open to the terminal channels, the terminals positioned in the terminal channels of the housing with the sacrificial sections aligned with the access openings.

5. The electrical connector assembly of claim 1, wherein the housing includes a locating element, the terminal including a locating element interacting with the locating element of the housing to axially position the terminal in the terminal channel.

6. The electrical connector assembly of claim 5, wherein the locating element of the housing includes a locating tab extending into the terminal channel, the locating element of the terminal including a locating shoulder configured to engage the locating tab to position the terminal relative to the housing.

7. The electrical connector assembly of claim 1, wherein the terminal includes a first passive electronic component connector extending from the first pad and a second passive electronic component connector extending from the second pad, the passive electronic component connected between the first and second passive electronic component connectors.

8. The electrical connector assembly of claim 7, wherein the first passive electronic component connector includes first contact springs interfacing with the passive electronic component and the second passive electronic component connector includes second contact springs interfacing with the passive electronic component.

9. The electrical connector assembly of claim 8, wherein the first contact springs include opposed first spring arms on opposite sides of a first pocket, the passive electronic component received in the first pocket between the opposed first spring arms, the second contact springs including opposed second spring arms on opposite sides of a second pocket, the passive electronic component received in the second pocket between the opposed second spring arms.

10. The electrical connector assembly of claim 1, wherein the terminal is configured to receive the passive electronic component in-line with the main body to connect the first and second pads after the sacrificial section is removed.

11. The electrical connector assembly of claim 1, wherein the housing includes a cover attached to the housing to hold the terminal in the terminal channel.

12. The electrical connector assembly of claim 1, wherein the passive electronic component includes one of a fuse, a resistor, a capacitor or a noise filter.

13. The electrical connector assembly of claim 1, wherein the terminating end includes a weld pad configured to be welded to the conductor, and wherein the mating end includes one of a socket, a pin, a spring beam, or a blade.

14. The electrical connector assembly of claim 1, wherein the first pad, the second pad, and the sacrificial section are coplanar.

15. The electrical connector assembly of claim 1, wherein the terminal includes a stamped and formed body having the mating end, the main body, and the terminating end forming an integral, unitary structure until the sacrificial section of the main body is removed to physically separate the second pad and the terminating end from the first pad and the mating end.

16. An electrical connector assembly comprising:
a flat flexible cable (FFC) having a substrate holding conductors, the conductors having ends at an end of the FFC;
an electrical connector terminated to the end of the FFC, the electrical connector including a housing holding terminals, the terminals being terminated to ends of the corresponding conductors, at least one of the terminals including a passive electronic component in-line with the terminal.

17. The electrical connector assembly of claim 16, wherein each terminal includes a mating end and a terminating end opposite the mating end configured to be terminated to the corresponding conductor, the terminal including a main body between the mating end and the terminating end, the main body including a first pad, a second pad, and a sacrificial section between the first pad and the second pad, the sacrificial section configured to be removed to separate the first and second pads, wherein the terminal is configured to receive the passive electronic component in-line with the main body to connect the first and second pads after the sacrificial section is removed

18. A terminal for an electrical connector, the terminal comprising:
a mating end configured to be mated to a mating contact of a mating electrical connector;
a terminating end opposite the mating end configured to be terminated to a conductor of a cable assembly;
the terminal including a main body between the mating end and the terminating end, the main body including a first pad, a second pad, and a sacrificial section between the first pad and the second pad, the sacrificial section configured to be removed to separate the first and second pads,
a passive electronic component coupled to the main body in-line between the mating end and the terminating end, the passive electronic component electrically connecting the first pad and the second pad after the sacrificial section is removed.

19. The terminal of claim 18, wherein the first pad is electrically connected to the second pad through the passive electronic component when the sacrificial section is removed.

20. The terminal of claim 18, wherein the terminal includes a first passive electronic component connector extending from the first pad and a second passive electronic component connector extending from the second pad, the first passive electronic component connector including first contact springs interfacing with the passive electronic component and the second passive electronic component connector including second contact springs interfacing with the passive electronic component, the passive electronic component connected between the first and second passive electronic component connectors.
